(19) United States
(12) Patent Application Publication
(10) Pub. No.: US 2005/0055299 A1
(43) Pub. Date: Mar. 10, 2005

(54) System and method for facilitating a request for proposal process

(76) Inventors: Phyllis Chambers, Rockport, MA (US); Brent Bannerman, Rockport, MA (US); Kevin Reed, Gloucester, MA (US)

Correspondence Address: MCDERMOTT, WILL & EMERY, 600 13th Street, N.W., Washington, DC, 20005-3096, US

(21) Appl. No.: 09/790,895

(22) Filed: Feb. 23, 2001

Related U.S. Application Data
(60) Provisional application No. 60/184,321, filed on Feb. 23, 2000.

(51) Int. Cl. G06F 17/60

(52) U.S. Cl. 705/36

(57) ABSTRACT

A software client can be used to prepare a complex request for proposal (RFP) that can include multiple bidding tiers, composite items and that can be fulfilled with non-conforming bids. The RFP is distributed to a number of bidders who submit bid quotes or alternative items. The amount of details disclosed to other bidders regarding the bids is selectable by the user. Revised bids are accepted for a predetermined time period, or until a threshold condition is reached, at which time the bids are compared and assessed to determine a winning bid. Once a winning bid is determined and a contract awarded, payment and settlement of the terms of the RFP can be monitored and tracked. A central computerized system, such as a web site, provides the data collection, data storage, data manipulation, connectivity functions, and messaging protocols used by the participants in the RFP marketing process.

### RELATED APPLICATIONS

This application relates to and claims priority from U.S. Application Ser. No. 60/184,321 filed Feb. 23, 2000 entitled METHOD FOR FACILITATING A REQUEST FOR PROPOSAL PROCESS, the disclosure of which is hereby incorporated in its entirety by reference.

### REFERENCE TO COMPUTER PROGRAM LISTING APPENDIX

A CD-ROM appendix of computer program listings is included with the present specification and consists of 680 files. The information of the CD-ROM Appendix is hereby incorporated by reference in its entirety.

### FIELD OF THE INVENTION

The present invention relates to distributed electronic marketplaces and, more particularly, to an on-line auction system configured to handle bidding on complex request for proposals.

### BACKGROUND OF THE INVENTION

Traditional Request for Proposal (RFP) marketing for complex group insurance products is a time consuming process for both the carrier and the broker. Multiple iterations of proposals and bids are required for each of the various carriers from whom bids are solicited. Furthermore, the arrangement and content of each bid is sufficiently different to make fair comparison of the bids a daunting undertaking. The conventional RFP process also is slow to reflect current market forces and typically results in clients paying a much higher price for insurance than is necessary.

One attempt at providing real-time dynamic pricing on the Internet has been on-line auction sites. However, these sites were initially geared towards business-to-consumer transactions that involved simple tangible goods that could be described and specified in detail. Some business-to-business auction sites have recently been developed but they also are geared towards tangible, supply-chain merchandise. To date, little success has been realized in market dealing with intangible goods and services, such as financial services, that have complex pricing models and deal in the selling and buying of “services”. Current auction efforts are also limited in that they are geared towards “atomic” bid items rather than “composite” bid items. For example, when a computer system is auctioned, the bidder must bid on the entire computer system and does not have the option of bidding individually on each of the components.

What is needed is a real-time, web-enabled auction engine for complex, intangible goods, with specific application to marketing requests for proposal such as for the group insurance marketplace.

### SUMMARY OF THE INVENTION

The present invention provides a marketplace for auctioning requests for proposal that can include complex pricing arrangements and variable arrangement of sub units within the request for proposal. One particular application for this marketplace is to facilitate the auctioning of requests for proposal relating to group insurance.

One aspect of the present invention relates to a system and method for auctioning insurance requests for proposal that generates a request for proposal based on the insurance needs of a client and makes the request for proposal available for access by a number of insurance carriers. Bids related to the request for proposal are received by the system and then ranked. The inventive system and method allow the processing and ranking of bids that include multiple pricing tiers, consist of different numbers of bid units, that deviate from the request for proposal. Furthermore, the ranking can be based, in part, on data extrinsic to the contents of the bid.

More generally, another aspect of the present invention relates to an auctioning process that involves requests for proposal (RFPs) with multiple elements and can receive and rank bids that provide quotes for less than all of the multiple elements of the RFP.

An additional aspect of the present invention relates to an auctioning process that involves requests for proposal (RFPs) with multiple elements and can receive and rank bids that do not conform to the elements identified in the RFP.

A further aspect of the present invention relates to an auction process that involves requests for proposal (RFPs) that request bids to address more than one pricing tier for the elements within the RFP and can receive and rank bids that include quotes for each of the multiple tiers. Additionally, the present invention allows a user to specify a formula for aggregating the different price quotes into a composite value for each bid.

One other aspect of the present invention relates to an auctioning process that involves requests for proposal (RFPs) having more than one bid unit and can receive and rank bids that create virtual bid units by conditioning the bid quote on whether the originator of the bid is awarded some predetermined sub-combination of the bid units in the RFP.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example hardware environment upon which an embodiment of the present invention may be implemented.

FIG. 2 illustrates an exemplary networked arrangement of entities using an embodiment of the present invention.

FIG. 3 illustrates a high-level flow diagram of one embodiment of an RFP auction process.

FIG. 4 illustrates a high-level flow diagram of another exemplary embodiment of an RFP auction process.

FIG. 5 illustrates an exemplary data diagram of exemplary information within an RFP.

FIG. 6 illustrates a flow diagram an exemplary RFP creation and distribution process according to an embodiment of the present invention.

FIG. 7 illustrates a flow diagram of an exemplary RFP auction process according to an embodiment of the present invention.

FIGS. 8, 9, 10 and 11 illustrate exemplary data reports that can be generated by embodiments of the present invention

### DESCRIPTION OF THE PREFERRED EMBODIMENT

To aid in the understanding of the present invention, exemplary embodiments are presented within the specific environment involving group insurance marketing. In general, however, the invention is applicable to other environments, for example financial services, where marketing of complex, intangible services having various methods of fulfillment, can be improved by an on-line auctioning process. Other applicable environments include marketplaces where goods and services are procured using complex, highly-detailed and varying requests for proposal that can be fulfilled in more than one unique manner. In the following description, for purposes of explanation, numerous specific details are set forth in order to provide a thorough understanding of the present invention. It will be apparent, however, to one of ordinary skill in the art that the present invention may be practiced without these specific details. In other instances, well-known structures and devices are shown in block diagram form in order to avoid unnecessarily obscuring the present invention.

### General Web Site Arrangement

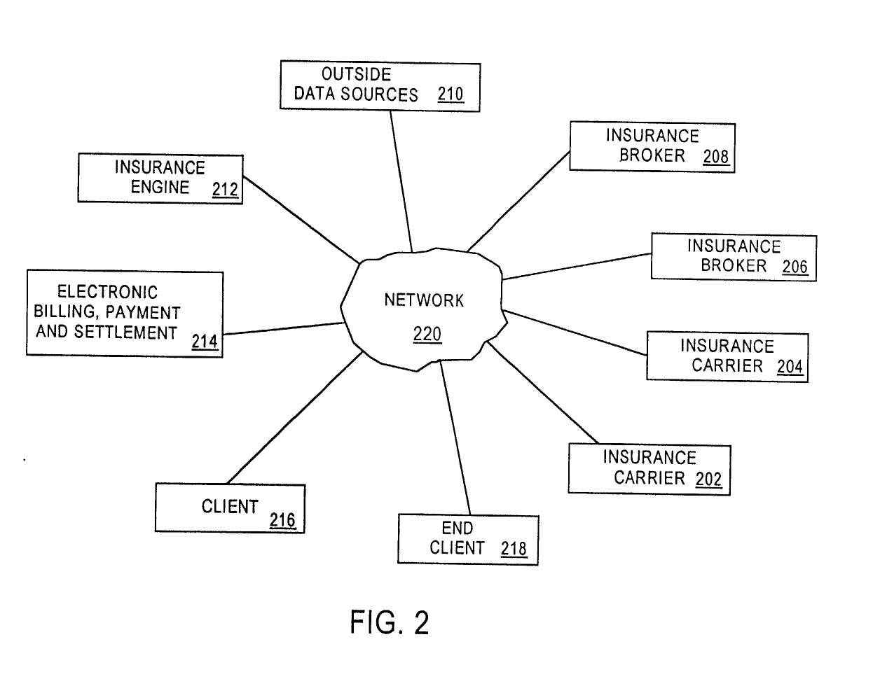

The environment of FIG. 2 illustrates one exemplary arrangement for an electronic distribution channel and marketplace, with particular applicability for procuring group insurance. This arrangement permits, for example, online creation, marketing, bidding, analyzing, auctioning, settling, invoicing and billing of insurance products among insurance brokers, carriers and clients. While the present invention could be used by a single individual searching for one or more insurance products, such a use would not take full advantage of all the features of the present invention. Therefore, in order to illustrate the flexibility and power of the present invention, the description provided herein, by way of example only, focuses on utilization of the invention for procurement of complex group insurance with multiple options, tiers and levels of services.

Within the exemplary environment of FIG. 2, the participating entities, which are more described again later, can include:
a client (216), typically a corporation or other multi-person group, who is attempting to procure a service, such as group insurance;
an insurance product or products that the client is interested in procuring, such as accidental death and dismemberment (AD&D), long-term disability (LTD), casualty, etc.
an insurance product template that is representative of typical specifications, characteristics and service levels for an insurance product;
an insurance broker or distributor (206, 208) that acts as an agent for a client to gather the client's insurance needs, prepare requests for proposal (RFPs) based on these needs, gather responses to the RFPs, and present the results to the client;
a corporation, or other business entity, who acts as an end client (218) by bypassing the distributor (i.e., broker) and dealing directly with an insurance carrier to procure insurance products;
a request for proposal (RFP) that is packaged by the distributor or the end client and typically includes the specifications for one or more insurance products as well as the rules and information regarding how the bidding process will be conducted;
an insurance carrier (202, 204) who offers various products and options to cover the insurance needs of clients; and
an insurance engine (212) that manages and supports communication and transactions among clients, distributors and carriers as well as monitors and analyzes the transactions in order to generate industry-wide, distributor-wide and/or client-wide statistics and reports.

The business-to-business electronic marketplace for insurance, illustrated in FIG. 2, is supported by the insurance engine 212 which allows the insurance needs of one or more clients 216 and 218 to be captured and packaged into an RFP that is distributed to one or more of the insurance carriers 202 and 204. A person can use the insurance engine to establish rules and dates for a bidding process and then manage communications related to the RFP in an auction-based manner. The carriers 202 and 204 can provide bids, ask questions, and present alternatives to the client 216 and 218 via the insurance engine 212. Once the auction date is closed, or some other predetermined response period has expired, the distributor 206 and 210, or possibly an end client 218, can use the insurance engine 212 to assess and evaluate bids and award an insurance contract. The insurance engine 212 can facilitate the insurance procurement transaction by providing access to extrinsic information 210 about the various entities and by providing billing, payment and settlement functionality 214.

FIG. 2 illustrates one exemplary arrangement in which the insurance engine 212 is depicted as an external third-party computing platform connected to the other participating entities via a network such as the Internet 220. In such an arrangement, the entities can preferably interface indirectly with each other via the insurance engine 212 and thereby permit the collection and monitoring of communications and transactions by the insurance engine 212. However, direct communication between the entities is also possible within the environment of FIG. 2. A more private network, utilization of distributed encryption protocols, a LAN or a WAN are also viable alternatives for providing the networking functionality of the Internet.

Rather than arranging the insurance engine 212 as a third-party entity, as depicted in FIG. 2, that can proxy communication between all the various brokers, clients and carriers, one alternative arrangement within the scope of the present invention would be to locate a separate insurance engine within the control of one or more of the brokers or end clients. In this alternative arrangement, only RFP auctions related to that particular broker or client would be managed by the particular, co-located insurance engine.

### Insurance RFP Marketing with Brokers

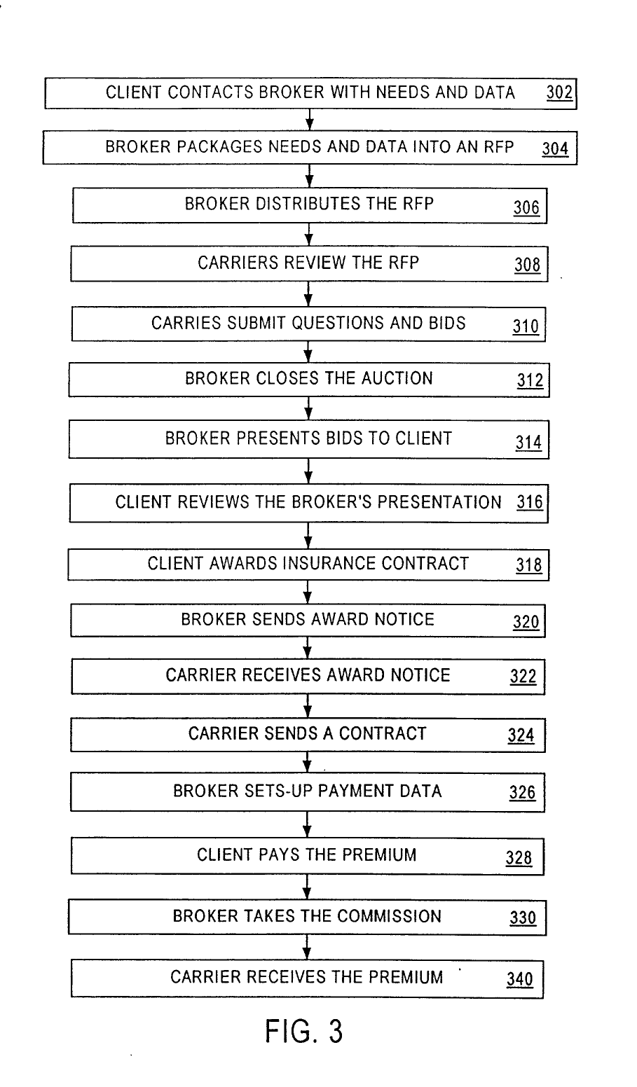

A high-level logical flow of an exemplary insurance RFP auction involving an insurance broker is depicted in FIG. 3. Further details of many of these high-level steps are described and explained with reference to later figures. In the performance of each step of the process, the insurance engine provides communications paths, data formatting and presentation functionality, insurance product templates, questionnaire templates, and default information that reduces errors, speeds processing, and provides competitive market forces to the benefit of all participants in the RFP process. The insurance engine allows an RFP participant to attach supporting documents to bids, RFPs and other data submissions. Using the registration and identification information maintained by the insurance engine for each participant, the insurance engine can instruct submitters regarding the document format preferred by another party, or the insurance engine can automatically convert documents between different formats.

Procuring an insurance product starts with the client providing (step 302) an insurance broker with a description of the insurance needs of the client, plan history data and census data about the client. The insurance needs of a client includes an identification of those insurance products that the client wants to procure. These products, for example, can include accidental death and dismemberment, short-term disability, long term disability, etc. The census data includes information useful by carriers to intelligently and accurately estimate and bid on a client's RFP. For example, if the client is a business and interested in procuring health insurance for its employees, then the census data may include, for example, the number of employees, gender-related statistics about the employees, dependent related statistics about the employees, age-related statistics about the employees, the types of work performed by the employees, and historical insurance claim statistics for the client. Plan history data such as claims, premiums and rates can also be included as supporting data within an RFP.

In step 304, the broker or insurance broker packages the client-identified insurance needs into an RFP. One benefit of the insurance engine is that brokers can arrange and format the data provided by a client into an RFP that insurance carriers are familiar with and that will simplify and speed the bidding process. The RFP typically includes explicit instructions regarding the rules and the time frame for bidding on the RFP. However, as one alternative, default bidding rules (e.g., auction closes in three weeks, all communications are made public, etc.) can be implemented if an RFP does not provide explicit instructions. The RFP also includes the census data and plan history data so that carriers can better assess their risks when formulating a bid.

An RFP can market an insurance product in more than one way. For example, the RFP may propose for bid a current plan design and an enhanced plan design. Additionally, the plan design may be altered as a result of feedback via the auction process. Ultimately, after assessing the different bids, one of the plan designs will be selected.

Once the RFP is generated by the insurance broker, the broker then distributes (step 306) the RFP to one or more insurance carriers. The distribution of RFP can be active in that the entire RFP (or the RFP and just a hyperlink to the census and history data) is sent to one or more carriers, or the distribution can be passive in that the carriers are informed of the new RFP and allowed to retrieve the RFP and data if they wish.

Next, in step 308, the insurance carriers review the RFP in order to determine whether or not they are interested in bidding on the RFP. After deciding to participate in the RFP auction, a carrier can communicate with the broker using multiple iterations (step 310) that allow the carrier to ask questions, receive answers and submit one or more bids related to the RFP. If the RFP includes a plurality of insurance products, the submitted bids can relate to all the insurance products within the RFP or relate to less than all the products (e.g., a sub-bid).

An RFP auction might include intermediate deadlines that all carriers must meet to remain active in the transaction; however, ultimately, a final auction-close date, or other predetermined threshold, will be reached that signals the end of the auction process. In step 312, the broker signals, or takes notice of, the close of the RFP auction.

After the auction closes, the broker analyzes the final carriers' bids and presents (step 314) them to the client. The insurance engine facilitates the clear presentation of the differing bids in order to aid in the client's review, analysis and comparison of the different bids (step 316).

Once the client selects the winning bid (step 318), the broker can notify (step 320) the winning carrier (step 322) who forwards (step 324) the insurance contract through the broker to the client. Alternatively, the exchange of the contract can be conducted of the network using electronic signatures and other data verification methods. Even after the RFP auction process concludes with the contract award, the insurance engine can provide assistance in the billing (step 326), payment (step 328) and settlement (steps 330 and 332) of the transaction. This assistance can include electronic payment, automatic bill generation, and automatic settlement procedures performed by the insurance engine itself or by third-party entities managed by the insurance engine.

### Insurance RFP Marketing with End Clients

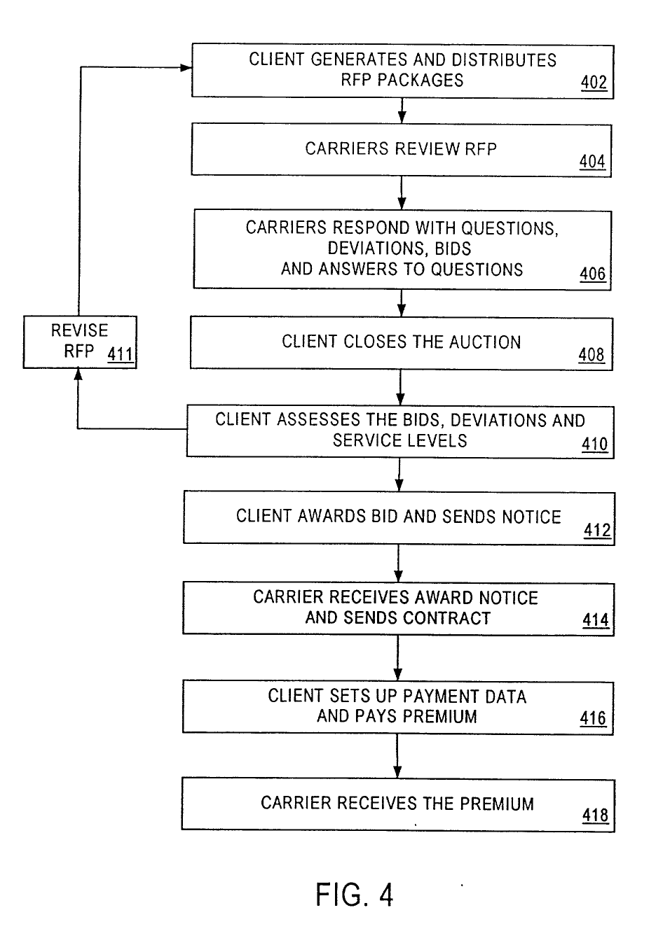

Some clients are experienced and knowledgeable enough to deal directly with insurance carriers without the presence of an insurance broker or agent. The insurance engine simplifies and speeds the insurance procurement process even further for such clients. FIG. 4 depicts a high-level logical flow of an exemplary insurance RFP auction involving an end client that bypasses the insurance broker. Many of the steps in FIG. 4 are similar to those of FIG. 3 except for the particular entity performing the step. Accordingly, in discussing the steps of FIG. 4, redundant information has been eliminated when possible.

In step 402, a client, based on their insurance needs, generates an RFP using the insurance engine and distributes the RFP to one or more selected insurance carriers. Similar to before, the carriers review (step 404) the RFP to determine if they are interested in bidding on the request. While the auction is open, interested carriers can respond (step 406) with questionnaire answers and questions of their own, they can also receive answers and, of course, submit bids.

According to the schedule provided by the RFP, the client closes (step 408) the auction and assesses (step 410) the terms within the different bids to determine a winning carrier. The client can then award the bid and notify (step 412) the carriers of the auction outcome. Upon receiving the award notice (step 414), the carrier forwards a contract to the client via the insurance engine, or other means. In response, the client sets-up a payment schedule (step 416) and the carrier receives the premiums (step 418) from the client. The insurance engine can be used to facilitate all steps of the process, including the electronic scheduling, payment and crediting of the premiums.

As a result of the bid assessment (step 410) a client may determine that the RFP needs to be modified or revised. Revisions can include changing a number of the RFP's specifications or simply identifying a reduced number of “finalists” to enter a new phase of pricing. A client can the revise (step 411) the RFP and distribute (step 402) it for review (step 404) by eligible carriers who perform the next round of pricing. The present invention also contemplates, within its scope, the occurrence of this multi-phase auction structure in the broker-enabled RFP process described earlier.

Additionally, such a multi-phase auction process can be planned in advance and structured to include multiple rounds of pricing and tweaking of the specification.

### Data Access

In one exemplary embodiment, the clients, brokers, carriers, and system management personnel all access the insurance engine via a web page, or similar, interface. For example, a client might access a central insurance engine web site or, alternatively, access a broker's web site that provides a portal to an insurance engine server. While the insurance engine itself (and its management personnel) has access to all the data available in order to manage a number of different RFPs, not all participants have equal or open access to all such data. Also, different levels of security may be accommodated depending upon the industry and regulatory environments which relate the to requests for proposal. Data access can also be controlled according to organizational rules. Clients, brokers and carriers can have multiple locations and employees working on a number of different RFPs. Through the use of workgroups, or similar functional designations, participant security profiles can limit data access according to specific RFPs, participants functional job requirements or tasks, location (e.g., access allowed to RFPs from specific locations of the company), reporting relationships (e.g., supervisors can access a staff's RFP), etc.

Data access rules govern, for example, the ability to add, modify, view, print, or delete data. In addition to data access being dependent on a participants role in an RFP transaction, overarching rules can also be implemented (e.g., after an RFP is distributed, no changes can be made to the RFP).

A client is involved with communicating with the broker at the beginning of the RFP process and is primarily involved only in insurance engine payment processes. Therefore, data access for clients may be limited to a broker version of a web site that is limited to the entering of insurance needs and the entering and viewing of payment details. Alternatively, a broker site may be configured to provide a client full access to any records pertaining to that client or a particular RFP.

Insurance brokers and corporate end clients will utilize the insurance engine to a fuller extent to create and submit data required to manage the RFP process and, therefore, can benefit from additional data access within the insurance engine. Furthermore, electronic messaging and other communication options can be provided to these participants to facilitate the functioning of the insurance engine.

Carriers are provided access to RFPs so that they can accurately bid in an auction and have varying access to other insurance engine data. This access varies for each RFP according to the rules of the RFP or default behavior implemented by the insurance engine.

System management personnel responsible for maintaining and providing the insurance engine to all the other participants have the fullest access to the data in order to aid in the support and maintenance of the system, monitor the transactions, and to measure and provide statistical data to outside parties. Similarly, system management personnel can also implement data archiving strategies, preferably with input from other participants, to ensure that accurate and adequate records of the brokered transactions are maintained.

With the above exemplary environment in mind, a more detailed look at the insurance engine participants and entities can now be provided.

### Client

Each RFP is associated with a client and the data maintained for each client can, for example, include identification data (e.g., name, address, phone number, fax, etc.), and one or more contact information (e.g., name, address, phone number, insurance product category, document format preference, etc.). Additionally, once the RFP process has concluded with a contract, the client can still use the insurance engine to perform payment and settlement processing. In such instances, data can be maintained for a client's payments that include an RFP identifier, insurance product identifier, contract date, rate, number of employees, remittance amount, premium amount, remittance method, date remitted, etc.

Also, for each client, related information can be maintained such as the identity of brokers associated with a particular client and past RFPs that have been processed on behalf of the client. Through this list of RFPs, historical details relating to products, templates, etc. can be made available to a broker, or other industry participants.

The client related data would typically be created and modified by a broker using the insurance engine. Typical data access by a broker may include viewing and printing of information on a single client or viewing and printing information on selected sub-sets of clients. For example, selected client sub-sets might include all clients associated with a particular broker, or all clients with RFP activity with a particular product type. Other access to client data can also include statistical processing of one or more clients' RFP history and monitoring payment compliance.

### Insurance Products

Insurance products can include, for example, Statutory Disability, Life Insurance, AD&D, STD, LTD, Health, Dental, Vision, Pension, Annuities, Property and Casualty, and Reinsurance. Associated with each product category is a service template that consists of a series of questions regarding service levels to be completed by the carrier during the RFP process. Each of these product categories can further include different product types. For example, the category of Statutory Disability may include 50 different product types—one for each state.

In a preferred embodiment, associated with each product type is a unique product template. Storage of the product templates is managed by the insurance engine. These templates include typical provisions or specifications associated with a product type and are useful to simplify and speed-up the RFP creation process. The insurance engine management personnel will typically be responsible for adding and modifying product category and product type information and for statistical analysis and reporting of product type activity or product category activity. A broker will typically access product data to view or print product categories and types, to determine those carriers providing a particular product type. Brokers will also typically access these templates when creating an RFP.

In addition to the product templates, brokers typically have questionnaire templates that have been developed for inclusion in an RFP. The insurance engine can store on-line versions of each broker's questionnaire templates for a particular insurance product and then provide access to them for customization during the generation of an RFP.

### Product Template

For each of the product types, a standard template is created and maintained by the insurance engine. Each template includes one or more provisions typically applicable to the associated insurance product. For example, “income replacement percentage” is a typical provision of any disability insurance product. When the broker is building an RFP for a client and retrieves a template, values are assigned by the broker to each of the specifications within the template. Additionally, within a template, a list of possible options for each specification could also be provided. The broker may then simply select an existing option or enter free-form text in a field associated with a particular template specification. The resulting RFP includes one or more completed product templates for a client.

The insurance engine provides an interface to a system manager that permits the creation and updating of product templates. Additionally, brokers can access the product template data for viewing, printing and downloading purposes. A carrier can, during the negotiation process, interact with a completed product template to simplify the entering of bid information that deviates from the client RFP. Similar functionality is also provided to both carriers and brokers with regard to the updating and completing of questionnaire templates.

### Insurance Broker

The insurance distributor, agent, or broker might easily be considered the primary user of the insurance engine in that they manage the RFP process on behalf of a client and perform much of the processing described herein. Contact and identification information, similar to that for a client, are maintained by the insurance engine for each broker. Also, data associated with a broker includes clients of the broker, carriers that broker does business with (preferably further segregated by product category), and RFPs previously created by that broker.

The insurance brokers are typically provided access to much of the data within the insurance engine which permits them to view information related to one or more associated clients, identify subsets of clients (e.g., all clients having a specific product category within an RFP), and view data related to selected RFPs and contract awards. The insurance engine provides powerful data examining and reporting tools that allow a broker to view RFP history by combinations of carriers that participated, carriers that declines, product types, clients, contract awards, etc.

### Corporate End Client

For the corporate end client that bypasses a broker and deals directly with the insurance carriers, the insurance engine maintains data and grants data access similar to that for the insurance broker. Some slight differences include the end client's lack of having a list of multiple, associated clients and the resulting ability to examine historical data segregated by client.

### RFP

The request for proposal (RFP) is made on behalf of the client by an insurance distributor (or by an end client itself) and sent out to one or more insurance carriers. The main components of an RFP include product and questionnaire templates completed for the client, the rules regarding the RFP, any current insurance contracts of the client relating to the content of the RFP, historical underwriting data (e.g., claims history, premiums, rates, etc.), and detailed employee data (i.e., census data).

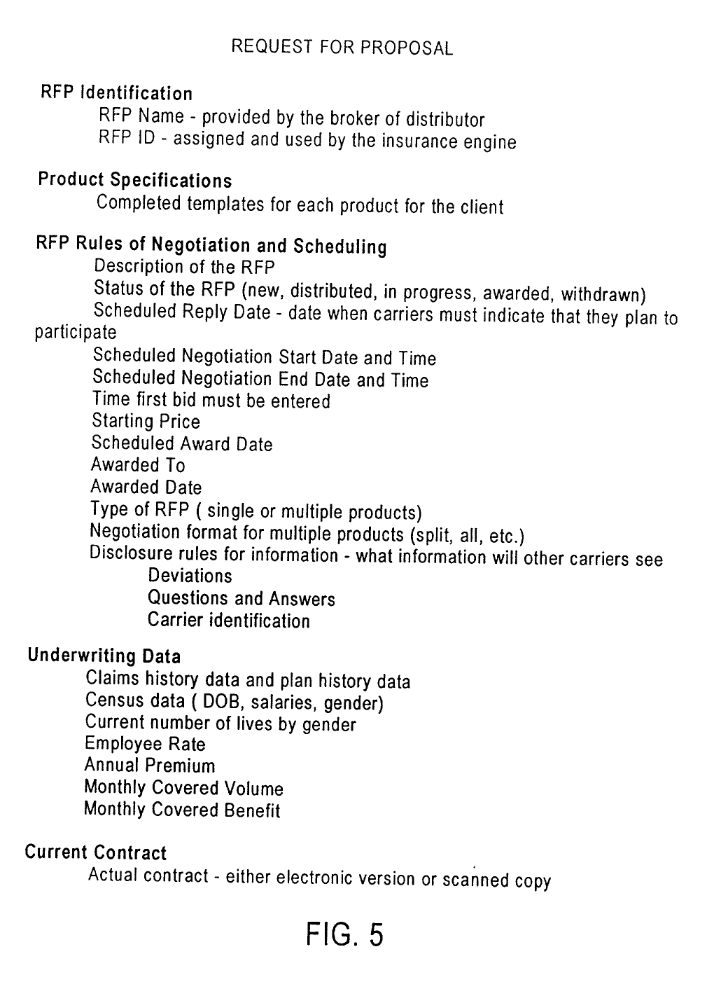

An exemplary RFP data diagram is depicted in FIG. 5. The illustrative data entities are provided by example only and, furthermore, not all the illustrated data is necessarily included in every RFP. Also, some of the data is not known when the RFP is first created but is manually or automatically updated as the RFP negotiation process proceeds.

### Insurance Carrier

Insurance carriers are registered with the insurance engine before being allowed to receive RFPs and participate in the bidding procedures. For each carrier, identification and contact information is maintained, similar to that for clients and brokers. Also, a list of product categories offered by a carrier is maintained. This list can be used by the insurance engine to automatically determine which carriers should receive a newly created RFP based on the product types included in the RFP. The broker responsible for an RFP can also limit the possible carriers that are eligible to participate in a particular RFP.

As a participant in the RFP process, the carrier has access to RFPs which they are eligible to receive, can submit bids, and receive replies and bid information from other carriers. The carrier can also use the insurance engine to acknowledge a contract award, forward a binding contract to the client, distribute policies, and receive premium payments.

### Insurance Engine

The insurance engine management personnel manage the application with respect to all customers (i.e. clients, brokers, and carriers). In this capacity, they do not actively participate in the actual negotiation process, but, instead, monitor and track the auction activity to provide any necessary support.

### The RFP Auction Process

An exemplary RFP auction process is now described that exemplifies many of the features of the present invention. The exemplary process includes many specific data examples. These examples are provided to assist with a clear explanation of the invention's features and are not intended to limit the scope and coverage of the invention. In particular, the following examples focus on an RFP process that includes the participation of a broker. As previously described, an end client can bypass the broker and also utilize the invention by dealing directly with insurance carriers.

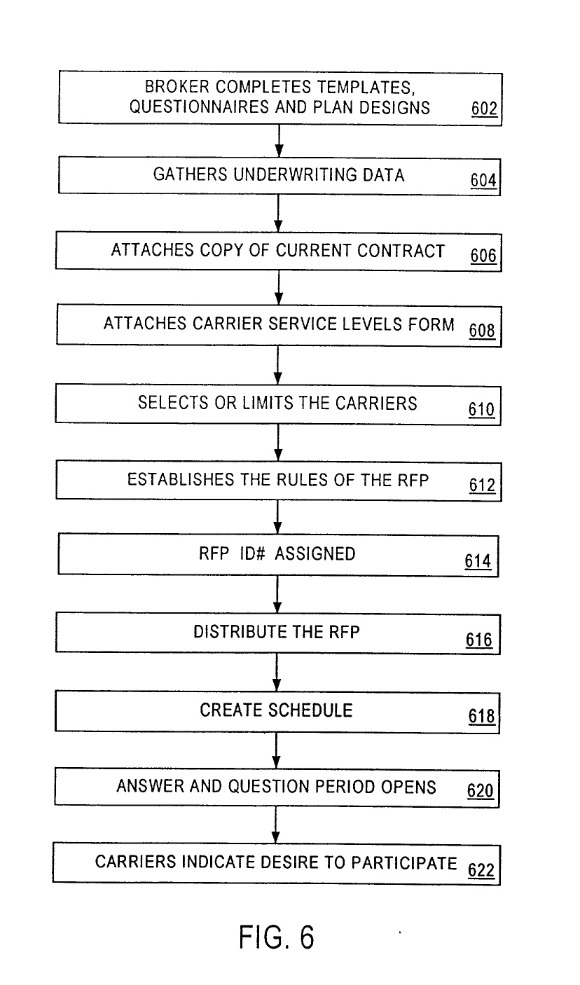

The RFP process begins with the creation and distribution of an RFP. FIG. 6 illustrates the logical flow of the RFP creation and distribution process. The broker begins by completing (step 602) one or more product templates, plan designs and questionnaire templates according to the client's insurance needs. Via an interface provided by the insurance engine, for example a web page, the broker is presented with and can select the desired insurance product types. In response, the insurance engine provides product and questionnaire templates that can either be completed on-line or, alternatively, be downloaded, completed off-line and then uploaded. Some preferred features of the insurance engine include saving the state of partially completed templates to allow brokers to return to previously started work and providing error checking routines to minimize incompleteness and errors within a submitted template.

Next, in step 604, the broker (or end client) provides historical data useful in the RFP process. An online or downloadable form can be provided to prompt the broker to provide the appropriate information to the insurance engine. Census data about employees can also be provided using conventional spreadsheet formats or via specialized data interfaces between the insurance engine and a client's human resources benefits system.

A copy of the client's current contract is also included (step 606) in the RFP. Either a scanned version or an electronic version of the contract can be provided by the broker. The broker can also include (step 608) in the RFP a carrier service levels form. The exact content of this form varies based on the insurance product category with which it is associated and includes requests for information from the carrier regarding various aspects of the service levels provided by the carrier. In participating in the RFP process, a carrier will complete this request form (on or off-line) and a client or broker can use the carrier's responses to measure and compare the different carriers.

Through the use of the carrier service levels form, the insurance engine can provide a method for identifying some measure of the extrinsic value of a bid. In an auction, an item has some extrinsic valuation if its valuation depends not only on the offered bid price but also on outside factors. For example, a medical insurance plan that is underwritten by a reputable carrier should, in theory, have more valuation than the same plan underwritten by a lesser-known carrier for the same bid price. Carrier reputation usually implies superior quality of service, speedy claim processing, easy claim filing, and wider acceptance by health care providers. The insurance engine can account for both the intrinsic and extrinsic valuation in the ranking and evaluation of bids.

To minimize the effort required by a broker to determine which carriers among a plurality of carriers to submit an RFP to, the insurance engine can provide the broker with a list of carriers that the broker does business with and that also provide the particular insurance product of interest to this RFP. The list can include information regarding the carriers as well as hyperlinks to additional information or the carriers' web sites. The brokers can then select (step 610) from the list, those carriers that will be eligible to participate in the RFP.

The rules of the RFP bidding and award process are then specified (step 612) by the broker. In addition to the auction timelines, the rules can include negotiation details, planned pricing phases, and other information such as that depicted in FIG. 5. Negotiation details may include whether the RFP requires a bundled bid on all the products or whether individual insurance products within the RFP can be bid on separately. The rules may specify that the bids must include pricing for different employee categories or geographic regions. When different pricing tiers are available to a carrier, the RFP can also include user-defined formulas that specify how the different bid prices are aggregated in order to determine the comparative ranking value for a bid.

The rules also notify the carriers regarding the scope of information disclosure during the bidding process. For example, will carriers see all the questions and answers regardless of who submitted the question or will they only be able to view their own questions and answers; will carriers be able to see just the bid amount from other carriers or all the bid data such as deviations and the resulting cost deltas, and will competing carriers be openly identified or merely aliased during the reporting of an auction.

After the RFP is completed and submitted by the broker, the insurance engine assigns (step 614) an RFP identification number and stores the RFP information. The RFP can then be distributed (step 616) by the insurance engine to the eligible carriers. The date and time of RFP distribution can be immediate or at a later time specified by the broker.

To accomplish the distribution process, the entire RFP package can be forwarded to each of the eligible carriers. However, the preferred method is to use the carriers' contact information maintained by the insurance engine to generate an e-mail (or other notification) message that is sent to each eligible carrier. This message would include information on the availability of a new RFP on the insurance engine web site and information on how to access it; these instructions could include passwords or other user authentication methods. The insurance engine can also notify the broker of the RFP's distribution as well as log any delivery errors related to the notification messages. The insurance engine also permits a broker to distribute the RFP to other carriers by adding carriers to the distribution list after the initial distribution.

Once the RFP is distributed, an appropriate calendar or schedule is automatically generated (step 618) and is associated with the RFP. Participants in a particular RFP transaction can access the insurance engine and view the calendar which provides details regarding the time and day of the scheduled events. Participants can also import the calendar into conventional calendaring applications that may be available on their local computer platforms.

The question and answer period preferably opens (step 620) as soon as the RFP is distributed. The RFP rules on disclosure of information govern how the questions and answers are shared among the carriers. The question and answer functionality provided by the insurance is essentially a two-way messaging system that helps clarify or address any questions regarding the RFP. Preferably, the questions and answers are logged and indexed to permit participants to locate and review questions and their answers according to carrier, subject matter, date, etc. The question and answer period can continue throughout the RFP bidding process and is not necessarily limited to only the early parts of the process.

The RFP rules also establish a reply date by which all carriers must indicate (step 622) their intent to participate in the RFP auction and to complete their service templates. The broker is provided with the option of extending these deadlines or for removing a carrier from an auction for failing to reply. Also, carriers can explicitly opt out of an auction.

While bids can preferably be received any time after the delivery of the RFP, it is anticipated that the majority of bids will start being received after the reply date has passed.

### Auction

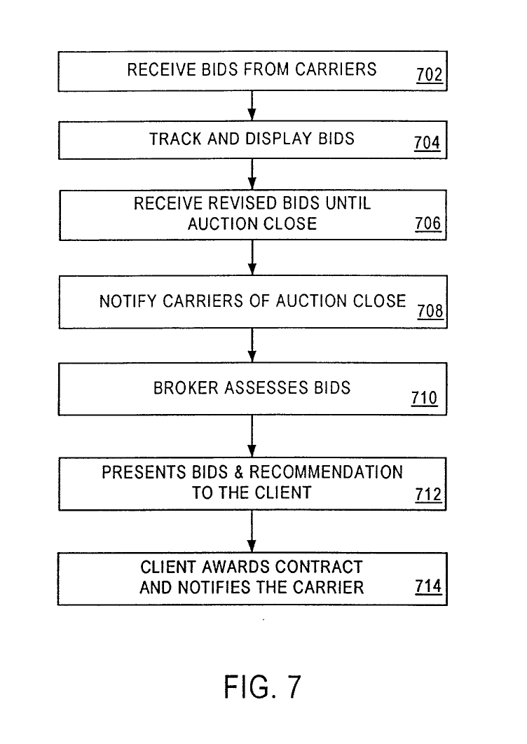

FIG. 7 depicts a logical flow of the RFP auction process. As per a particular RFP's rules, the dates and times of auction events are pre-scheduled for the duration of an auction. During the auction, the carriers who choose to participate in the auction respond with bids that are submitted (step 702) to the insurance engine via various electronic document submission techniques. The received bids to the RFP are tracked and displayed (step 704) with respect to all the carriers. According to the RFP's rules, some of the bid information is shared with all the carriers and some information is accessible only by the broker.

In a preferred embodiment, the receipt of any bid in an auction will cause the insurance engine to automatically generate a message notifying all the participating carriers of the existence of a new bid. The carriers can then access the insurance engine web site and view a display of the bid history for that auction. Different levels of detail are, of course, available depending on the amount of bid information allowed for display.

In response to a bid by another carrier, some carriers may revise their bid to be more competitive and submit (step 706) this revised bid to the insurance engine. The display of bids by the insurance engine and the submission of revised bids by the carriers can repeat until the auction closes. The insurance engine can send (step 708) notification of the close of the auction to the carriers (and other participants).

As many RFPs can include multiple insurance products, the insurance engine provides carriers the ability, in addition to submitting one composite bid, to easily drill down into an RFP to identify individual products and to submit separate bids. As a result, the insurance engine also provides brokers views of RFP bids arranged according to overall bid data as well as by individual products.

The insurance products included in an RFP can also involve multiple pricing tiers. Unlike conventional auctioning environments, the auction process provided by the insurance engine is configured to handle such complex price structures. For example, a medical insurance plan consisting of various benefits could be offered at the following tiers: single employee, married employee, and employee with dependents. A client with a diverse work force may seek bids with explicit price quotes on each of these tiers.

When submitting a bid for a multi-tier auction item, the carrier is required to enter a price for each tier. Accordingly, the winning bid depends on the prices entered for all the tiers according to a user-defined formula that can differ for different clients. This user-defined formula specifies how the vector of tier prices is aggregated to compute a single value that is used for valuation and ranking of a bid for that client.

Supporting the vector-pricing model is implemented by the insurance engine by allowing the broker, or the end client, to specify the number of tiers for each insurance product in an RFP. In addition to identifying the tiers, the broker also provides the insurance engine with the formula to aggregate the different bid quotes for the tiers. In a preferred embodiment, the broker can also specify error checking or constraining formulas that define the acceptable ranges of values within these tiers and whether there is an interdependency regarding the values within each tier.

Another powerful provision of the insurance engine is that it permits carriers to submit bids that deviate from the exact provisions of the RFP. A simple example from the computer industry might involve a computer system including a 20 GB hard drive and 64 MB of memory. By allowing deviations, a bidder is not limited to only the specific requested item but can present a bid for supplying a system with 128 MB of memory but only a 15 GB hard drive for a particular price. In the medical insurance environment, a carrier may respond to an RFP asking a 20% co-pay option with an offer than includes 10% co-pay but only a slightly higher premium. By allowing such deviations, the insurance engine permits a broker to see and evaluate these “alternative”, non-conforming bids.

In a preferred embodiment, the carrier can access an online version of a completed product template that is included in an RFP, edit the values in the template to reflect the deviations, and submit the revised document as a bid. Also, carriers can download questionnaires, complete them off-line, and upload them back into the insurance engine. This process allows the carrier to easily and quickly generate the bid and provides the bid in a format that permits the deviations to be easily recognize and extracted. Usually, any deviation will also involve a price differential associated with that deviation. The insurance engine can maintain two separate files for deviations—one file for the details of the deviations themselves and the other file for the price information. Such an arrangement will permit the deviation information but not the price information to be displayed to all carriers if the disclosure rules so dictate.

Another possible deviation is a multiple product discount. The insurance engine allows the carrier to identify bid alterations that depend on the carrier receiving all or part of the RFP's business. In practice, one exemplary method to implement this feature is to allow the carrier to submit a scaling factor that is multiplied against the bid price if the carrier's conditions are met. As for the display provided by the insurance engine, the other carriers may see the scaled bid price and the bid alteration conditions but the actual scaling factor may be protected from disclosure.

For example an auction can involve a car and a truck each of which is expected to be awarded to the highest bidder. However, a bidder may be inclined to provide a better bid if guaranteed receiving both the car and the truck. The bidder is, thus, able to dynamically create new competitive units out of existing ones. In the simple example, the bidder can enter a blended bid for the car-truck combination and a two bid-unit auction is transformed into a three bid-unit auction. In general, an auction with n items can have up to n factorial possible bid units. The bid data that the insurance engine accepts and stores permits the insurance engine to value and rank bids that have different numbers of bid units.

The RFP can also be structured to solicit bidding according to different pricing models. Thus, an RFP for a single plan design can generate alternative pricing schedule. For example, the RFP can ask for a product to be priced on a fully-insured basis and on a partially-insured basis.

After the auction closes and the final bids from the carriers are received. The broker (or end client) can assess (step 710) the bids. In a preferred embodiment, the insurance engine provides report generating capabilities that allows a broker to view different bid information ranked in a table, ranked in a side-by-side arrangement, or in an overlay format. The ability for a broker to rank and sort the data by one or more of products, individual product prices, individual tier prices, composite prices, the absence or presence of deviations, annual premiums, monthly costs, etc. are all contemplated within the scope of the present invention. Accordingly, bids that conform in aspects to the RFP, bids that address less than every individual product within the RFP, bids with deviations, bids with virtual bid units, and bids with multiple price tiers can all be ranked and presented together in user-selectable reports. These data reports that summarize the data to simplify assessments can also include hyperlinks to the full RFP bid in order to provide access to the complete carrier proposal as needed. The broker can select and view predefined reports or generate a custom report when using the insurance engine to generate a presentation for recommending (step 712) to the broker's client which carrier (or carriers) to award the insurance contract to.

The RFP auction ends with an insurance contract being awarded (step 714) to one or more insurance carriers.

### Sample Reports

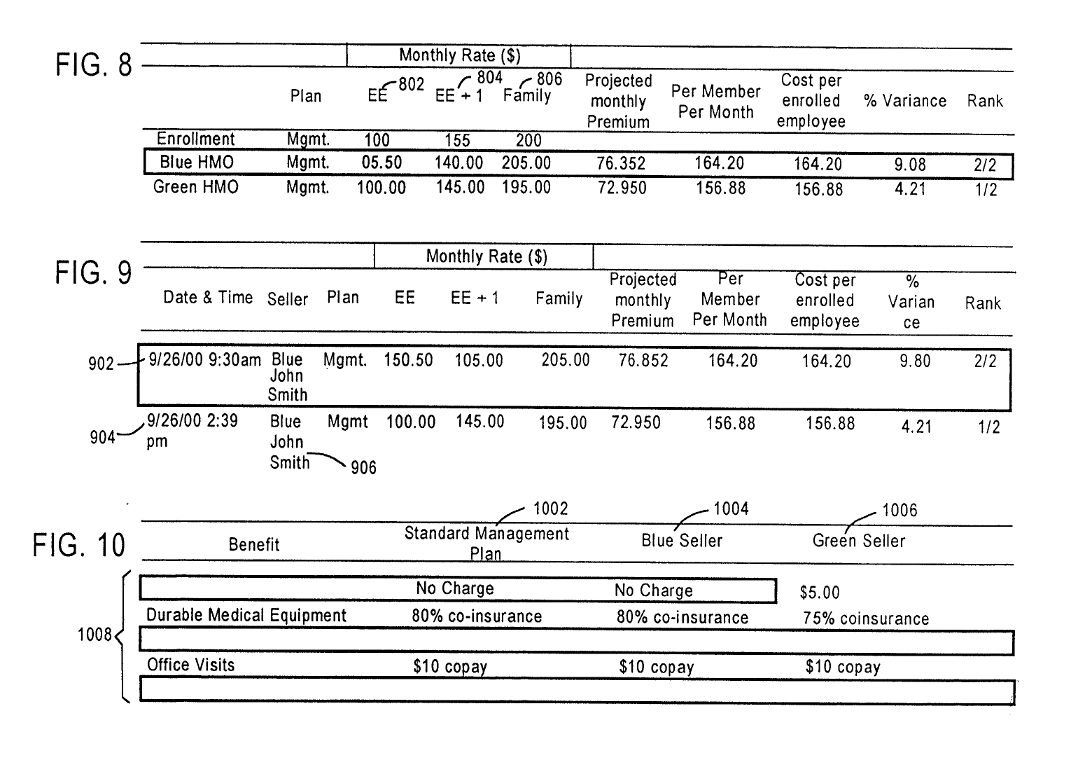

FIGS. 8, 9, 10 and 11 illustrate example reports that a broker can generate using the insurance engine. Some report formats are anticipated to be so useful that they are predefined within the insurance engine. Examples of such reports include, a side-by-side comparison of the RFP vs. a seller plan, a side-by-side comparison of a seller vs. a seller, a rate summary table that compares final bids, and a rate history table that itemizes bids throughout the auction period.

An exemplary rate summary table is illustrated in FIG. 8 that displays the final bid for each option 802, 804 and 806. The other columns of the table are filled in automatically by the insurance engine using pre-gathered information about the client's employees and the other bids.

An exemplary rate history table is illustrated in FIG. 9 and displays all bids 902 and 904 entered by carrier “Blue” during the auction. This table can be modified to include information from other carriers or to suppress the name 906 of the individual that submitted the bid.

A exemplary plan comparison report is illustrated in FIG. 10 that displays a side-by-side comparison of the RFP plan 1002, the carrier “Blue” plan 1004; and the carrier “Green” plan 1006. When defining the creation of this report within the insurance engine environment, the broker can identify those carriers to include in the table as well as which items 1008 to display in the table.

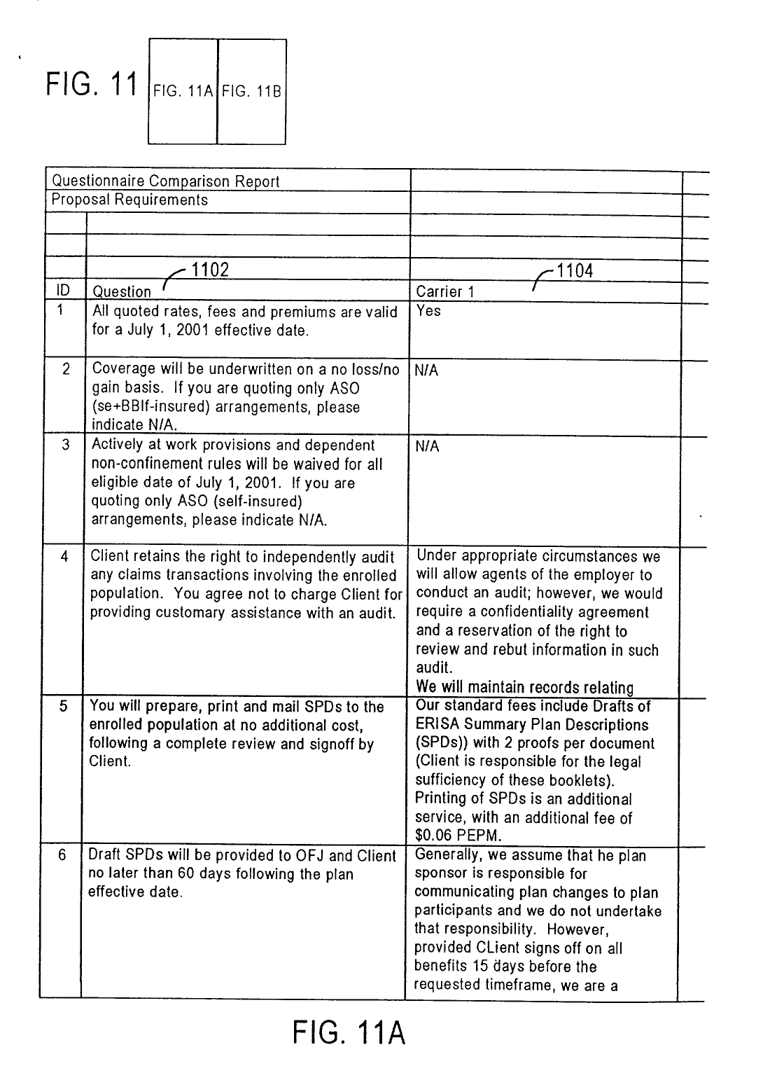

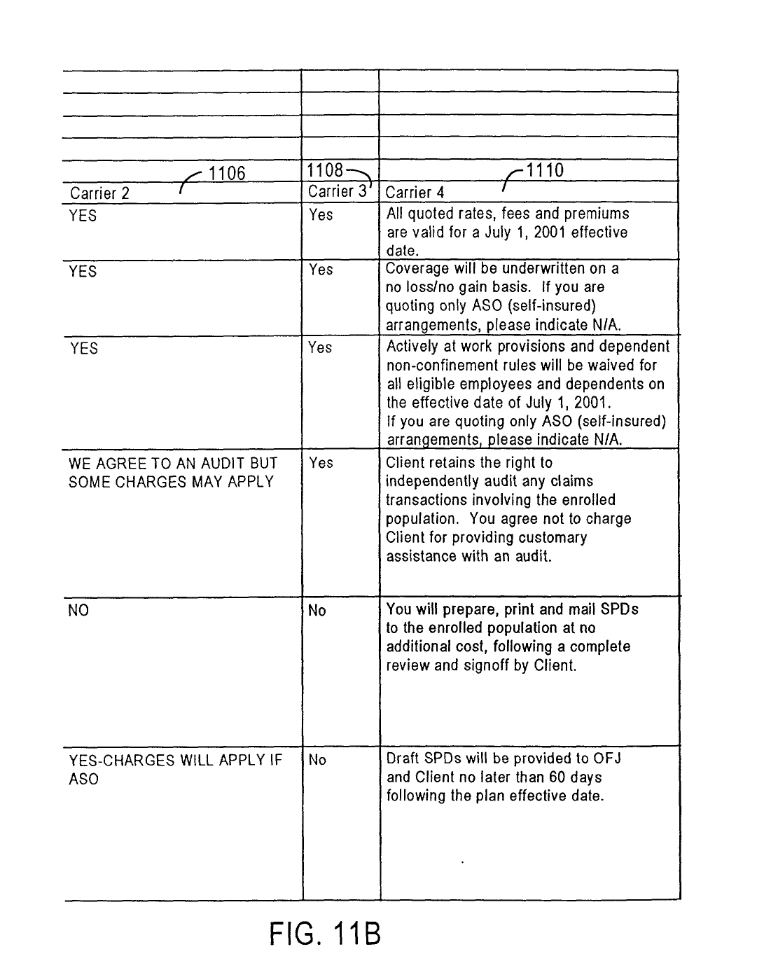

FIG. 11 illustrates another predefined report that displays a comparison of questionnaire responses. A matrix, for example, is shown that lists the questions in the left column 1102 and the responses from a number of different carriers in columns 1104, 1106, 1108, and 1110. As shown, the insurance engine permits carriers to respond with as much or as little detail as possible and can present the carriers' responses in an easy to read and analyze format.

### Settlement

Even after the contract has been awarded, the insurance engine can continue being used to provide a carrier with invoices automatically generated from the carrier's bid information and pricing. Alternatively, an invoice template could be provided on-line which the carrier can complete and submit to the broker. The client can respond to the invoice with automatic electronic payments or other, more conventional methods. Regardless of the payment methods, the insurance engine can receive and log payment information and payment history. Additionally, the insurance engine can also calculate the broker's commission and automatically subtract that amount from any payments.

In addition to facilitating a particular RFP transaction, the insurance engine can include data analysis and reporting routines that permit users to analyze historical data regarding winning bids, head-to-head statistics regarding the success of particular competitors, pricing trends for different products, and participation statistics by different entities. The insurance engine essentially services all the participants in the RFP process and simplifies the roles and efforts of each participant by providing pertinent data, open communication paths between parties, flexible data analysis tools, and predefined templates that facilitate data entry.

### Hardware Overview

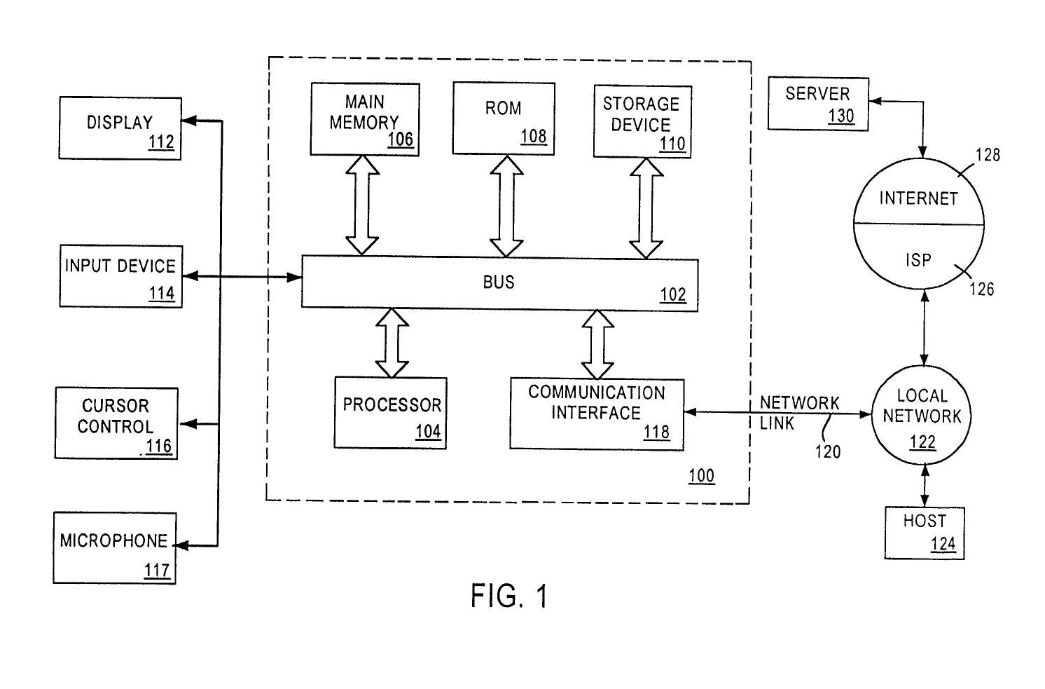

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

While this invention has been described in connection with what is presently considered to be the most practical and preferred embodiment, it is to be understood that the invention is not limited to the disclosed embodiment, but on the contrary, is intended to cover various modifications and equivalent arrangements included within the spirit and scope of the appended claims. The invention is capable of other and different embodiments and its several details are capable of modifications in various obvious respects, all without departing from the invention. Accordingly, the drawings and description are to be regarded as illustrative in nature, and not as restrictive.

1. A method for auctioning a request for proposal for group health insurance comprising the steps of:
generating the request for proposal, said request identifying one or more insurance products;
providing a plurality of insurance carriers access to the request for proposal; and
receiving at least one bid, each of said at least one bid relating to the request for proposal and received from one of the plurality of insurance carriers.

2. The method according to claim 1, wherein the request for proposal comprises one or more different insurance product descriptions.

3. The method according to claim 2, further comprising the steps of:
for each of the one or more product descriptions, providing a template associated with the product description.

4. The method according to claim 3, wherein each of the templates comprises:
one or more specifications based on the associated product description, and
one or more values associated with at least one of the one or more specifications.

5. The method according to claim 1, wherein the request for proposal comprises one or more pricing tiers and each of the received plurality of bids includes a separate price quote corresponding to each of the one or more pricing tiers.

6. The method according to claim 1, further comprising the step of:
ranking the received plurality of bids.

7. The method according to claim 1, wherein the request for proposal comprises a formula for ranking the received plurality of bids.

8. The method according to claim 7, further comprising the step of:
ranking the received plurality of bids according to the formula.

9. The method according to claim 2, wherein a particular one of the received at least one bid comprises a separate price quote for each of the one or more different insurance product descriptions.

10. The method according to claim 9, wherein the request for proposal comprises a formula for generating an aggregate value from the separate price quotes.

11. The method according to claim 10, wherein the particular one bid is ranked, in relation to any other of the received at least one bid, according to the aggregate value.

12. The method according to claim 1, wherein one or more of the received at least one bid does not conform to the request for proposal.

13. The method according to claim 1, further comprising the step of:
providing the plurality of insurance carriers access to at least a portion of each of the received at least one bid.

14. The method according to claim 1, further comprising the steps of:
receiving a determination of a winning carrier from among the plurality of carriers;
managing payment of an insurance premium to the winning carrier, said payment managed in accordance with the request for proposal; and
storing one or more records relating to the payment of the insurance premium.

15. The method according to claim 14, wherein the step of managing payment includes the steps of:
receiving identification of a source of electronic funds; and
causing the transfer of the payment from the identified source to the winning carrier.

16. The method according to claim 1, further comprising the steps of:
receiving extrinsic information relating to a particular one of the received at least one bid; and
evaluating the particular one bid based, in part, on the extrinsic information.

17. A system for providing an electronic marketplace for an insurance related request for proposal, said system comprising:
an interactive request for proposal builder configured to generate the request for proposal, said request for proposal identifying one or more insurance products.
a first memory configured to store the request for proposal and further configured to limit access to the request for proposal to only a select plurality of insurance carriers;
a second memory configured to store one or more bids relating to the request for proposal received from at least one of the select plurality of insurance carriers, and further configured to permit the select plurality of insurance carriers to view at least a portion of the stored one or more bids.

18. The system according to claim 17, further comprising:
a data analyzer configured to rank the one or more bids stored in the second memory.

19. The system according to claim 17, wherein the request for proposal comprises one or more different insurance product descriptions.

20. The system according to claim 19, further comprising a third memory configured to store a template associated with each of the one or more product descriptions.

21. The system according to claim 17, wherein the request for proposal comprises a formula for evaluating the one or more bids.

22. The system according to claim 17, wherein the request for proposal comprises one or more different pricing tiers.

23. The system according to claim 18, further comprising:
a third memory configured to store extrinsic information relating to at least one of the one or more bids, and wherein the data analyzer is further configured to adjust the rank of the one or more bids based on the extrinsic information.

24. The system according to claim 17, wherein at least one of the one or more bids deviates from the request for proposal.

25. A computer readable medium bearing instructions for auctioning a request for proposal for group health insurance, said instructions being arranged to cause one or more processors upon execution thereof to perform the steps of:
generating the request for proposal, said request identifying one or more insurance products;
providing a plurality of insurance carriers access to the request for proposal; and
receiving at least one bid, each of said at least one bid relating to the request for proposal and received from one of the plurality of insurance carriers.

26. The computer readable medium of claim 25, the instructions being further arranged to cause the one or more processors to perform the step of:
ranking the received plurality of bids.

27. A method for auctioning a request for proposal, comprising the steps of:
receiving from a client one or more item descriptions;
generating the request for proposal based on the item descriptions;
providing access to the request for proposal to a plurality of bidders; and
receiving one or more bids relating to the request for proposal from at least one of the plurality of bidders, wherein at least one of the one or more bids comprises sub-bids, each of said sub-bid related to only one of the one or more item descriptions.

28. The method according to claim 27, further comprising the step of:
ranking the at least one of the one or more bids relative to any other of the one or more bids.

29. A method for auctioning a request for proposal, comprising the steps of:
receiving from a client one or more item descriptions;
generating the request for proposal based on the item descriptions;
providing access to the request for proposal to a plurality of bidders; and
receiving none or more bids relating to the request for proposal from at least one of the plurality of bidders; and
receiving one or more non-conforming bids relating to the request for proposal from at least one of the plurality of bidders, wherein each non-conforming bid comprises a price and at least one alternative item different from the one or more item descriptions.

30. The method according to claim 29, further comprising the step of:
ranking the none or more bids and the one or more non-conforming bids relative to each other.

31. A method for auctioning a request for proposal, comprising the steps of:
receiving one or more item descriptions and a plurality of pricing tiers;
receiving a formula for evaluating bids;
generating the request for proposal based on the item descriptions and the plurality of pricing tiers;
providing access to the request for proposal to a plurality of bidders; and
receiving one or more bids relating to the request for proposal from at least one of the plurality of bidders, wherein each bid comprises associated sub-bids corresponding to each of the plurality of pricing tiers.

32. The method according to claim 31, further comprising the step of:
ranking the one or more bids relative to each other.

33. The method according to claim 31, further comprising the steps of:
generating a composite rank for each of the one or more bids according to the formula; and
ranking the one or more bids according to the composite rank for each bid.

34. A method for auctioning a request for proposal, comprising the steps of:
receiving from a client one or more item descriptions;
generating the request for proposal based on the item descriptions, said request for proposal comprising a plurality of bid units;
providing access to the request for proposal to a plurality of bidders; and
receiving one or more bids relating to the request for proposal from at least one of the plurality of bidders, wherein at least one of the one or more bids comprises a quote conditioned on a combination of the bid-units ultimately being awarded to a sender of the quote.

35. The method according to claim 34, further comprising the step of:
ranking the at least one of the one or more bids relative to any other of the one or more bids.

36. A method for auctioning a request for proposal, comprising the steps of:
receiving from a client one or more item descriptions;
generating the request for proposal based on the item descriptions;
providing access to the request for proposal to a plurality of bidders;
receiving one or more bids relating to the request for proposal from at least one of the plurality of bidders; and
receiving extrinsic information relating to one or more of the plurality of bidders.

37. The method according to claim 36, further comprising the step of:
ranking the one or more bids based on bid content and on the extrinsic information.

38. The method according to claim 2, further comprising the steps of:
revising the request for proposal based on the received at least one bid;
providing another plurality of insurance carriers access to the revised request for proposal; and
receiving at least one revised bid, each of said at least one revised bid relating to the revised request for proposal and received from one of the another plurality of insurance carriers.

39. The method according to claim 38, wherein the plurality of insurance carriers is a superset of the another plurality of carriers.

40. The method according to claim 38, wherein the step of revising includes:
modifying at least one of the one or more different insurance product descriptions.
